(19) United States
(12) Patent Application Publication
(10) Pub. No.: US 2009/0319907 A1
(43) Pub. Date: Dec. 24, 2009

(54) EVALUATION OF ORDERED LISTS TO DETERMINE SIMILARITY BETWEEN CONNECTED USERS OF A NETWORK

(76) Inventor: Lance Tokuda, Foster City, CA (US)

Correspondence Address: Raj Abhyanker LLP;c/o Intellevate, P.O. Box 52050, Minneapolis, MN, 55402, US

(21) Appl. No.: 12/143,794

(22) Filed: Jun. 22, 2008

(51) Int. Cl. G06F 3/00; G06F 17/30

(52) U.S. Cl. 715/739; 707/5; 707/E17.001

(57) ABSTRACT

The method and system to evaluation of ordered lists to determine similarity between connected users of a network are disclosed. In one embodiment, a method includes presenting a defined list having ‘n’ number of options of a set of items to a user of a network, allocating the set of items of the defined list to a preference list when the user of the network identifies which of the ‘n’ number of options are preferred, determining a preference of the user based on which of the ‘n’ number of options are preferred earlier than other ones of the ‘n’ number of options, generating an ordering of the user in response to the defined list when all the ‘n’ number of options are individually selected and allocated to the preference list by the user based on an order of selection of each of the ‘n’ number of options by the user.

### FIELD OF TECHNOLOGY

This disclosure relates generally to a technical field of software and/or hardware technology and, in one example embodiment, to method and system of evaluation of ordered lists to determine similarity between connected users of a network.

### BACKGROUND

A network (e.g., a Facebook®, MySpace®, Bebo®, LinkedIn®, etc.) may include a number of users connected to each other through the network. For example, a particular user may request connections (e.g., a link, a direct access to, a shared visibility of profiles, etc.) with other users who are acquaintances, friends, school colleagues, and/or business associates through the network. Over time, the particular user may amass a large number of other users connected with the particular user through the network. However, the particular user may not recall (e.g., may forget) how and/or why the particular user is connected with certain ones of the other users.

As a result, bonds may grow weaker between the particular user and the other users. Furthermore, the particular user may infrequently communicate with the other users connected with the particular user. As a result, the other users may recall preferences, tastes, and/or affinities of the particular user. Therefore, bonds between connected users of the network (e.g., the particular user and other users connected with the particular user) may grow weaker over time.

### SUMMARY

A method, system, and apparatus to evaluation of ordered lists to determine similarity between connected users of a network are disclosed. In one aspect, a method includes presenting a defined list having ‘n’ number of options of a set of items to a user of a network, allocating the set of items of the defined list to a preference list when the user of the network identifies which of the ‘n’ number of options are preferred, determining a preference of the user based on the which of the ‘n’ number of options are preferred earlier than other ones of the ‘n’ number of options, generating an ordering of the user in response to the defined list when all of the ‘n’ number of options are individually selected and allocated to the preference list by the user based on an order of selection of each of the ‘n’ number of options by the user, comparing the ordering of the user with other users connected to the user through the network to generate a score, and generating a similarity value between the user and at least one of the other users connected to the user through the network by applying an algorithm to the score, and when at least one user has provided responses to the defined list having the ‘n’ number of options.

The method may include removing the set of items of the defined list when the set of items of the defined list may be allocated to the preference list. The method may populate the preference list as each of the set of items may be individually moved from the defined list to the preference list. The method may render the preference list on a right-side location of a mark-up language page having the defined list on a left-hand location of the mark-up language page (e.g., such that both the defined list and the preference list may be simultaneously displayed to the user having a limited display area).

The method may include generating a counter showing remaining one of the options in the defined list when the set of items of the defined list may be allocated to the preference list and removed from the defined list. The limited display area may be associated with a laptop computer and/or a mobile communication device. The method may also include modifying the preference list when the user may indicate through a final answer module that the options of the preference list are not in a preferred order.

The method may move a last selected item back to the defined list from the preference list when the user may indicate that the options of the preference list are not in the preferred order. All items on the defined list may be populated into the preference list before the ordering is generated. The options preferred earlier by the user may be associated with items that are more desirable to the user. Options preferred last by the user may be associated with items less desirable to the user. The set of items of the defined list may be associated with a topic of the defined list.

The method may include applying a signed weighting to each option based on the order of selection of each of the ‘n’ number of options by the user. The method may use a statistical probability algorithm to determine a correlation between the user and the other users to determine the similarity value. A bias may be placed toward favoring similarity between the user and other user through a biasing value when determining the correlation between the user and the other users. The method may also include customizing a user-definable defined list based on a criteria of the user. The method may share the user-definable defined list with other user. The method may permit only the user that created the user-definable defined list to delete the user-definable defined list.

In another aspect, the method includes creating a connection between a first user of a network and a second user of the network, determining a first ordering of the first user and a second ordering of the second user based on selected preferences on a defined list of a topic when the first user and a second user independently remove items from the defined list to a preference list in an order of desirability of items of the defined list, and generating a similarity value between the first user and the second user based on an algorithm that places signed weights based on the order of the selected preferences.

The method may include removing a set of items of the defined list when the set of items of the defined list may be allocated to the preference list. The method may also include populating the preference list as each of the set of items may be individually moved from the defined list to the preference list. In addition, the method may render the preference list on a right-side location of a mark-up language page having the defined list on a left-hand location of the mark-up language page such that both the defined list and the preference list are simultaneously displayed to a user having a limited display area (e.g., the limited display area may be associated with a laptop computer and/or a mobile communication device).

The method may include generating a counter that may show remaining ones of the options in the defined list when the set of items of the defined list are allocated to the preference list and /or removed from the defined list. The method may include modifying the preference list when the first user and/or the second user may indicate through a final answer module that the options of the preference list are not in a preferred order. The method may also move a last selected item back to the defined list from the preference list when the first user and the second user indicate that the options of the preference list are not in the preferred order.

In yet another aspect, a system includes a defined list module to create a defined list having ‘n’ number of options of a set of items to a user of a network, an allocation module to transfer the set of items of the defined list to a preference list when the user of the network identifies which of the ‘n’ number of options are preferred, a priority module to determine a preference of the user based on the which of the ‘n’ number of options are preferred earlier than other ones of the ‘n’ number of options, a ordering module to determine a ordering of the user in response to the defined list when all of the ‘n’ number of options are individually selected and allocated to the preference list by the user based on an order of selection of each of the ‘n’ number of options by the user, an evaluation module to compare the ordering of the user with other users connected to the user through the network to generate a score, and a similarity module to determine a similarity value between the user and at least one of the other users connected to the user through the network by applying an algorithm to the score when at least one user of the other users has provided responses to the defined list having the ‘n’ number of options.

The system may include a weighing module to apply a signed weighting to each option based on the order of selection of each of the ‘n’ number of options by the user. The system may also include a statistics module to apply a statistical probability algorithm to determine a correlation between the user and the other users to determine the similarity value. In addition, the system may include a bias module to favor similarity between the user and other user through a biasing value when determining the correlation between the user and the other users.

The system may include a customization module to permit a user-definable defined list based on a criteria of the user. The system may yet also include a sharing module to communicate the user-definable defined list with other user. In addition, the system may include a delete module to permit only the user that created the user-definable defined list to delete the user-definable defined list.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of the client devices communicating with likeness module and network module through an internet, according to one embodiment.

FIG. 2 is an exploded view of likeness module of FIG. 1, according to one embodiment.

FIG. 3 is a user interface view illustrating a topic guide from which a topic can be selected and placed in the selected topic space, according to one embodiment.

FIG. 4A is a user interface view illustrating a selection of topic from defined list and adding the selected topic to the preference list based on a preference of a user, according to one embodiment.

FIG. 4B is a user interface view illustrating a selection of topic (e.g., second option) from a defined list and adding the selected topic to a preference list based on the preference of the user, according to one embodiment.

FIG. 4C is a user interface view illustrating a selection of topic (e.g., third option) from the defined list and adding the selected topic to the preference list based on a preference of the user, according to one embodiment.

FIG. 4D is a user interface view illustrating completed preference list by selecting the options from the defined list and adding them into the preference list based on preferences of the user, according to one embodiment.

FIG. 5 is a table view illustrating algorithm for determining the similarity between the users, according to one embodiment.

FIG. 6 is a system view illustrating calculation of similarity value algorithm, according to one embodiment.

FIG. 7 is a user interface view illustrating likeness profile, according to one embodiment.

FIG. 8 is a diagrammatic system view of a data processing system in which any of the embodiments disclosed herein may be performed, according to one embodiment.

FIG. 9A is a process flow of presenting a defined list having ‘n’ number of options of a set of items to a user of a network, according to one embodiment.

FIG. 9B is a continuation of process flow of FIG. 9A, illustrating additional operations, according to one embodiment.

FIG. 9C is a continuation of process flow of FIG. 9B, illustrating additional operations, according to one embodiment.

FIG. 10A is a process flow of creating a connection between a first user of a network and a second user of the network, according to one embodiment.

FIG. 10B is a continuation of process flow of FIG. 10A, illustrating additional operations, according to one embodiment.

Other features of the present embodiments will be apparent from the accompanying drawings and from the detailed description that follows.

### DETAILED DESCRIPTION

The method, system, and apparatus to evaluation of ordered lists to determine similarity between connected users of a network are disclosed. Although the present embodiments have been described with reference to specific example embodiments, it will be evident that various modifications and changes may be made to these embodiments without departing from the broader spirit and scope of the various embodiments.

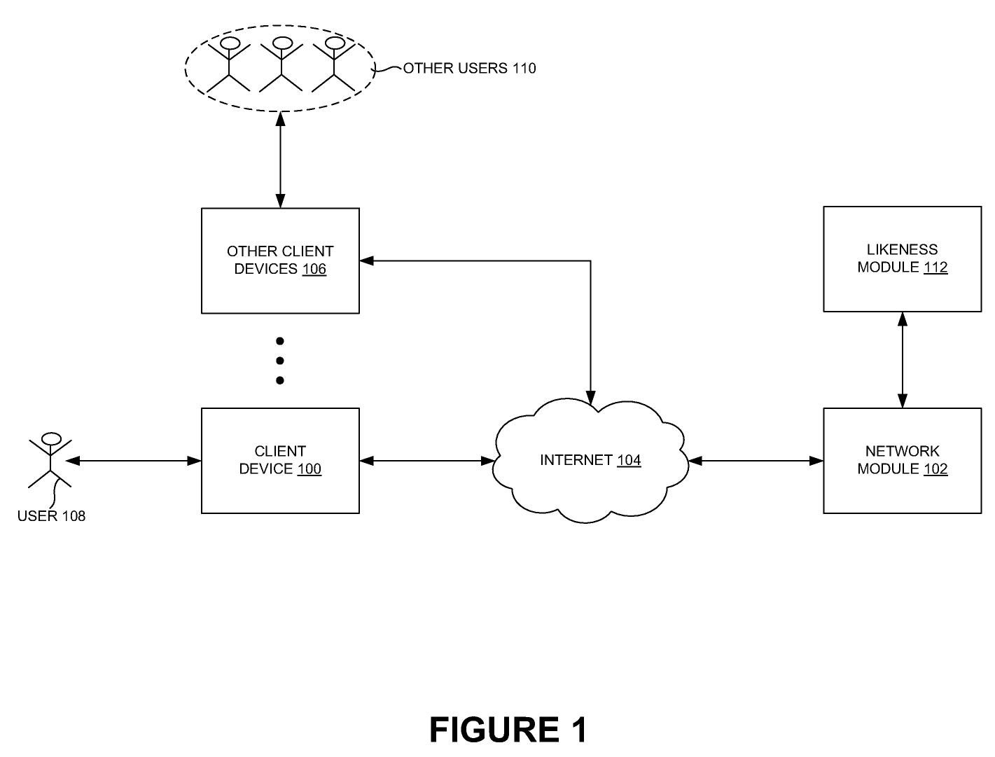

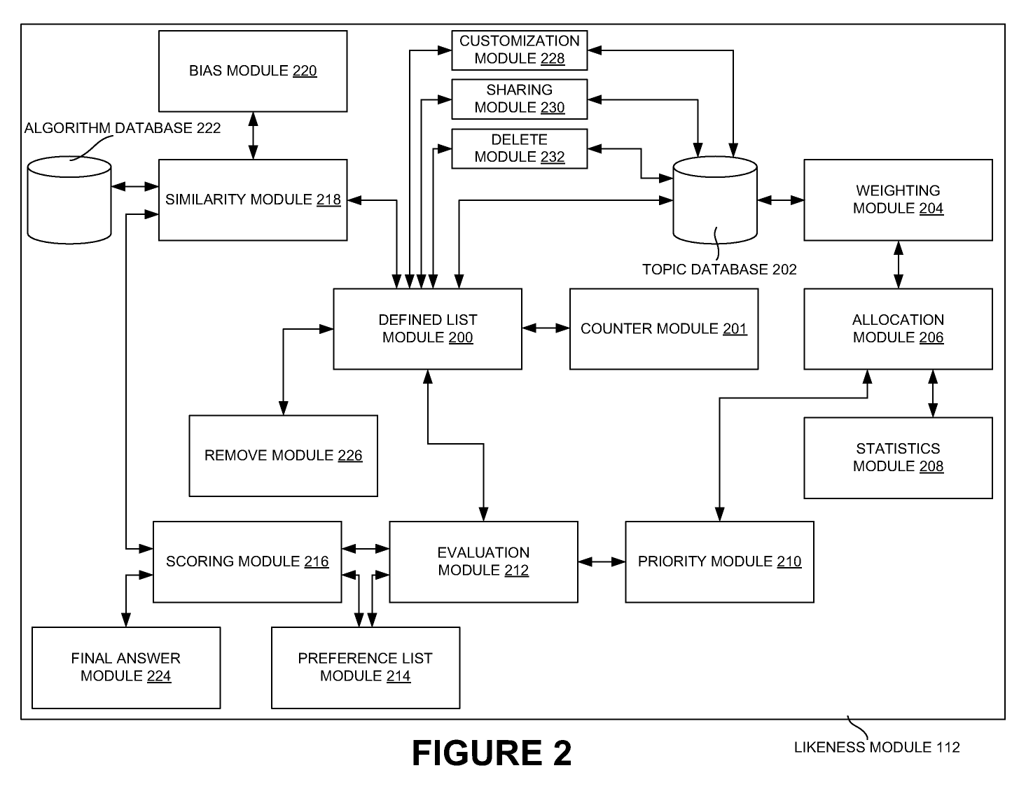

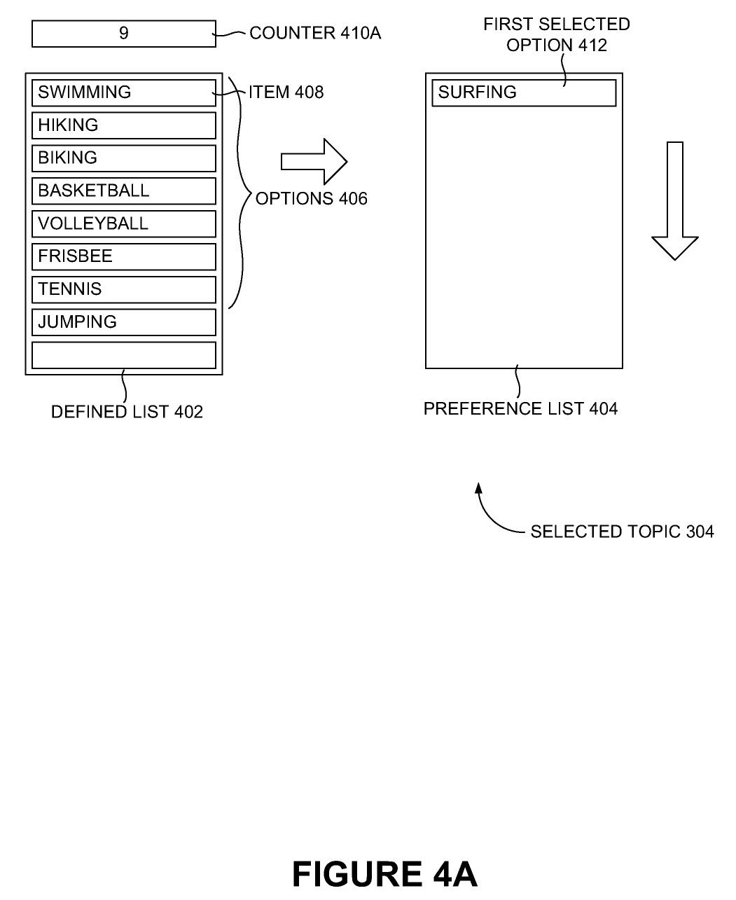

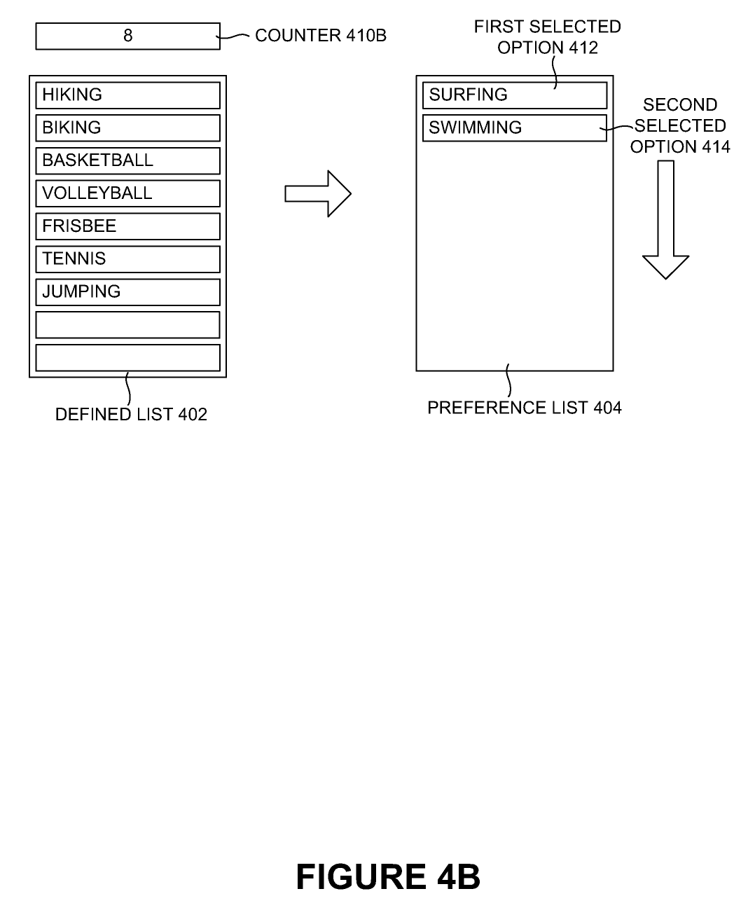

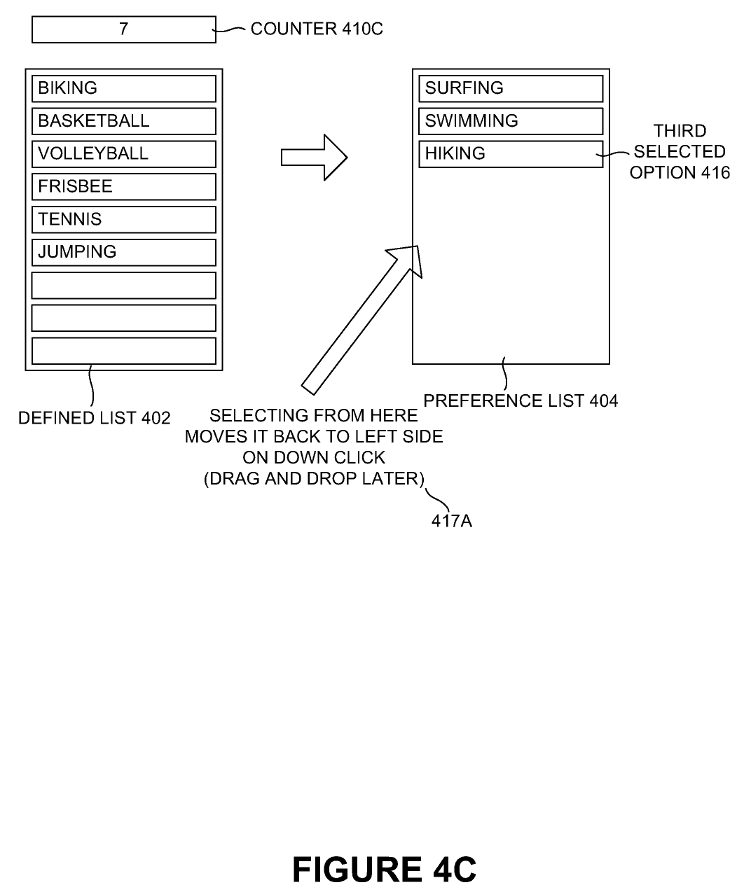

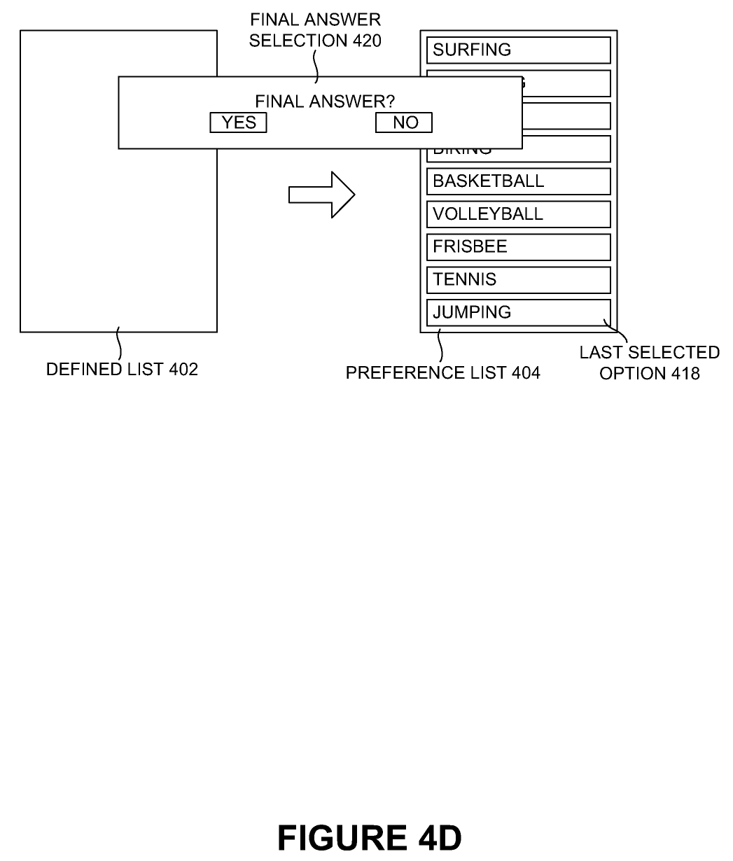

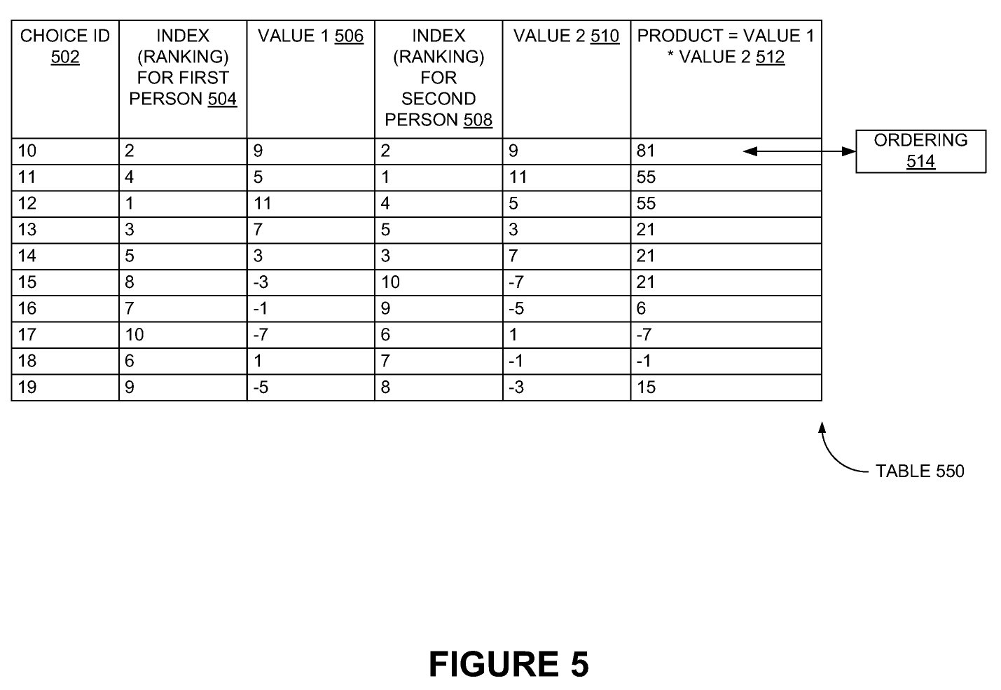

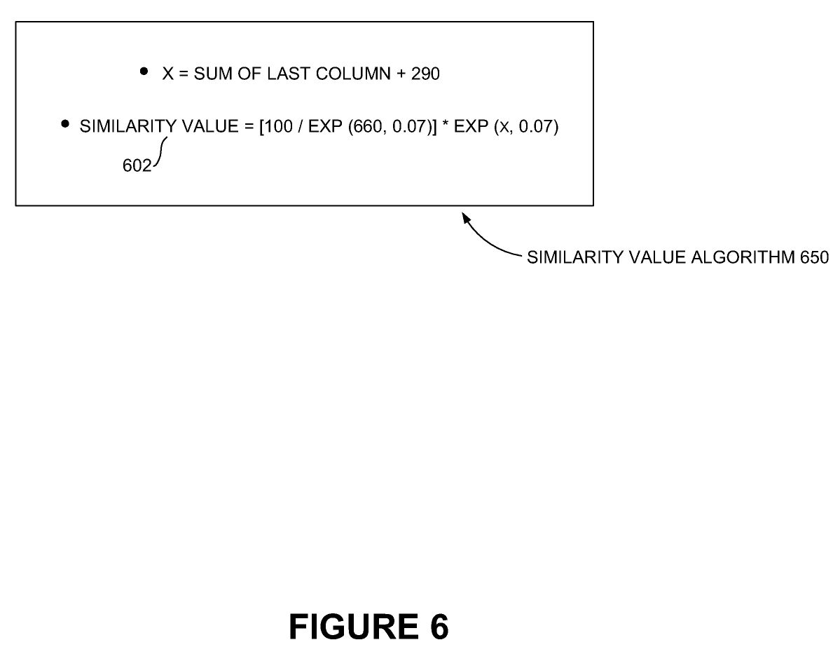

In one embodiment, a method includes presenting a defined list (e.g., the defined list 402 of FIG. 4) (e.g., may include swimming, hiking, biking, basketball, etc.) having ‘n’ number of options of a set of items to a user (e.g., the user 108 of FIG. 1) of a network (e.g., the internet 104 of FIG. 1), allocating the set of items of the defined list 402 to a preference list (e.g., the preference list 404 of FIG. 4) when the user 108 of the network identifies which of the ‘n’ number of options are preferred (e.g., using the allocation module 206 of FIG. 2), determining a preference of the user 108 based on the which of the ‘n’ number of options are preferred earlier than other ones of the ‘n’ number of options (e.g., using the priority module 210 of FIG. 2), generating an ordering (e.g., the ordering 514 of FIG. 5) of the user 108 in response to the defined list 402 when all of the ‘n’ number of options are individually selected and allocated to the preference list 404 by the user 108 based on an order of selection of each of the ‘n’ number of options by the user 108 (e.g., using the ordering module 216 of FIG. 2), comparing the ordering 514 of the user 108 with other users (e.g., the other users 110 of FIG. 1) connected to the user 108 through the network to generate a score, and generating a similarity value (e.g., the similarity value 602 of FIG. 6) between the user 108 and the other users 110 connected to the user 108 through the network by applying an algorithm to the score, and when at least one user of the other users has provided responses to the defined list 402 having the ‘n’ number of options.

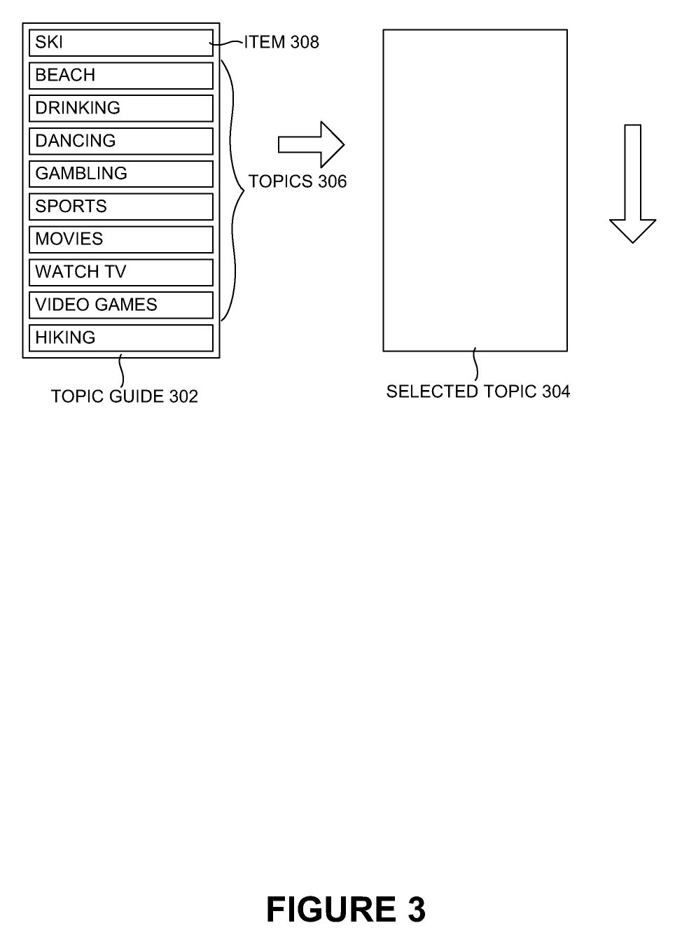

In another embodiment, a method includes creating a connection between a first user of a network (e.g., the network of FIG. 1) and a second user of the network, determining a first ordering of the first user and a second ordering of the second user based on selected preferences on a defined list (e.g., the defined list 402 of FIG. 4) of a topic (e.g., the topics 306 of FIG. 3) when the first user and a second user independently remove items from the defined list 402 to a preference list (e.g., the preference list 404 of FIG. 4) in an order of desirability of items of the defined list 402, and generating a similarity value (e.g., the similarity value 602 9f FIG. 6) between the first user and the second user based on an algorithm that places signed weights based on the order of the selected preferences.

In yet another embodiment, a system includes a defined list module (e.g., the defined list module 200 of FIG. 2) to create a defined list (e.g., the defined list 402 of FIG. 4) (e.g., may include swimming, hiking, biking, basketball, volleyball, etc.) having ‘n’ number of options of a set of items to a user (e.g., the user 108 of FIG. 1) of a network (e.g., the internet 104 of FIG. 1), an allocation module (e.g., the allocation module 206 of FIG. 2) to transfer the set of items of the defined list 402 to a preference list (e.g., the preference list 404 of FIG. 4) when the user 108 of the network identifies which of the ‘n’ number of options are preferred, a priority module (e.g., the priority module 210 of FIG. 2) to determine a preference of the user 108 based on the which of the ‘n’ number of options are preferred earlier than other ones of the ‘n’ number of options, a ordering module (e.g., the ordering module 216 of FIG. 2) to determine a ordering of the user 108 in response to the defined list 402 when all of the ‘n’ number of options are individually selected and allocated to the preference list 404 by the user 108 based on an order of selection of each of the ‘n’ number of options by the user 108, an evaluation module (e.g., the evaluation module 212 of FIG. 2) to compare the ordering of the user 108 with other users 110 connected to the user 108 through the network to generate a score, and a similarity module (e.g., the similarity module 218 of FIG. 2) to determine a similarity value between the user 108 and the other users 110 connected to the user 108 through the network by applying an algorithm to the score when at least one user of the other users has provided responses to the defined list 402 having the ‘n’ number of options.

FIG. 1 is a system view of the client devices communicating with likeness module and network module through a network, according to one embodiment. Particularly, FIG. 1 illustrates client device 100, a network module 102, an internet 104, an other client devices 106, a user 108, an other users 110, and a likeness module 112, according to one embodiment.

The client device 100 may be a data processing system (e.g., computer, laptop, mobile, etc.) which may communicate with the network module 102 through the network to enable the user to access applications (e.g., likeness module). The network module 102 may enable the communication between the client device 100, other client devices 106 and the likeness module 112 through the internet. The internet 104 (e.g., an interconnected system of networks that may connect computers around the world via the TCP/IP protocol) may enable communication between the client device 100, other client devices 106 and the network module.

The other client devices 106 may be a data processing system (e.g., computer, laptop, mobile, etc) which may be used by the other users 110 for accessing the applications (e.g., likeness module 112) on the internet. The user 108 may be a person, patron etc. who may access the application (e.g., likeness module 112) through the client device 100 via the internet 104. The other users 110 may be any of the users (e.g., person, patron etc.) connected to the network who may wish to access the application (e.g., likeness module 112) to check their likeness with the other users 110. The likeness module 112 may be an application (e.g., software application, web application, etc.) that may enable the user 108 and/or the other users 110 to check their likeness with the user 108 and/or other users 110.

In example embodiment, the user 108 may communicate with the client device 100. The other users 110 may communicate with the other client devices 106. The other client devices 106 and/or the client device 100 may communicate with likeness module 112 through the network module 102 using the internet 104.

In one embodiment, the connection may be created between the first user (e.g., the user 108) of the network and the second user (e.g., may be the other users 110) of the network.

FIG. 2 is an exploded view of the likeness module 112 of FIG. 1, according to one embodiment. Particularly, FIG. 2 illustrates a defined list module 200, a counter module 201, a topic database 202, a weighting module 204, an allocation module 206, a statistics module 208, a priority module 210, an evaluation module 212, a preference list module 214, a ordering module 216, a similarity module 218, a bias module 220, an algorithm database 222, a final answer module 224, a remove module 226, a customization module 228, a sharing module 230, and a delete module 232, according to one embodiment.

The defined list module 200 may create defined list associated to users (e.g., the user 108 and/or the other users 110 of FIG. 1) that may have ‘n’ number of options 406 of a set of items (e.g., ski, beach, drinking, etc.). The counter module 201 (e.g., may be a register) may generate the counts illustrating the number of options remaining in the defined list 402 when the user 108 and/or the other users 110 selects the items from the defined list 402 to the preference list 404 based on the preference of the user 108 and/or the other users 110. The topic database 202 may be a collection of the set of items that may/may not be associated to the user 108 and/or to the other users 110.

The weighting module 204 may apply a signed weighting (e.g., may be orderings based on likeness) to each of the option based on the order of selection by the user 108. The allocation module 206 may transfer (e.g., allocate) the set of items (e.g., swimming, hiking, biking, etc.) of the defined list 402 to the preference list 404. The statistics module 208 may apply a statistical probability algorithm to determine a correlation between the user 108 and the other users 110 (e.g., to determine their similarity value). The priority module 210 may determine the preference of the user 108 based on the options that are preferred earlier compared to the other options in among the ‘n’ number of options. The evaluation module 212 may compare the ordering of the user 108 with the other users 110 connected to the user through the network (e.g., may be through social community environments).

The preference list module 214 may populate the preference list 404 of the user 108 selected among the ‘n’ number of options from the defined list 402. The ordering module 216 may determine a ordering of the user 108 based on the options selected by the user 108 (e.g., based on the users preferences) in the defined list 402. The similarity module 218 may determine a similarity value 602 (e.g., that may be calculated using the similarity value algorithm) between the user 108 and the other users 110, when the user 108 may have provided responses to the defined list 402 having the ‘n’ number of options. The bias module 220 may favor similarity between the user 108 and the other users 110 through a biasing value (e.g., that may leverage the similarity ordering). The algorithm database 222 may be a collection of algorithms (e.g., the statistical probability algorithm, the similarity value algorithm, etc.) that may be used to determine correlation, likeness, etc. between the user 108 and/or the other users 110.

The final answer module 224 may enable modification of the order of the options the preference list 404 when the user 108 indicates that the preference list is not in the preferred order. The remove module 226 may enable removing of the options in the preference list 404 when the user 108 indicates that the set of items of the preference list 404 is not in the preferred order of the user 108. The customization module 228 may permit the user 108 to customize a user-definable defined list based on criteria of the user 108. The sharing module 230 may communicate the user-definable user defined list with the other users 110 connected through the network. The delete module 232 may allow the user 108 that created the user-definable defined list to delete the user-definable defined list.

In example embodiment, the defined list module 200 may communicate with counter module 201, the topic database 202, the remove module 226, the evaluation module 212, the similarity module 218, the customization module 228, the sharing module 230, and the delete module 232. The defined list module 200 may communicate with weighting module 204 through the topic database 202. The allocation module 206 may communicate with the weighting module 204, the statistics module 208, and the priority module 210. The evaluation module 212 may communicate with the defined list module 200, the priority module 210, the preference list module 214, and the ordering module 216. The ordering module 216 may communicate with the preference list module 214, the evaluation module 212, the final answer module 224 and the similarity module 218. The similarity module may communicate with the algorithm database 222, and the bias module 220.

In one embodiment, the defined list 402 having ‘n’ number of options of the set of items may be presented (e.g., using the defined list module 200 of FIG. 2) to the user 108 (e.g., through the user interface) of the network. The set of items of the defined list 402 may be allocated (e.g., using the allocation module 206 of FIG. 2) to the preference list 404 when the user 108 of the network identifies which of the ‘n’ number of options are preferred. The preference of the user 108 may be determined (e.g., using the priority module 210 of FIG. 2) based on which of the ‘n’ number of options are preferred earlier than other ones of the ‘n’ number of options. The ordering of the user 108 may be generated (e.g., using the ordering module 216 of FIG. 2) in response to the defined list 402 when all of the ‘n’ number of options are individually selected and/or allocated to the preference list 404 by the user 108 based on the order of selection of each of the ‘n’ number of options by the user 108.

The ordering of the user 108 may be compared with other users 110 connected to the user 108 through the network (e.g., using the evaluation module 212 of FIG. 2) to generate a score. The similarity value (e.g., the similarity value 602 of FIG. 6) may be generated (e.g., using the similarity value algorithm 650 of FIG. 6) between the user 108 and the other users 110 connected to the user 108 through the network by applying an algorithm to the score, and when one user of the other users has provided responses to the defined list 402 having the ‘n’ number of options (e.g., using the similarity module 218 of FIG. 2). The set of items of the defined list 402 may be removed (e.g., using the remove module 226 of FIG. 2) when the set of items of the defined list 402 are allocated to the preference list 404.

The counter showing remaining ones of the options 406 may be generated (e.g., using the counter module 201 of FIG. 2) in the defined list 402 when the set of items of the defined list 402 are allocated to the preference list 404 and removed from the defined list 402. The limited display area may be associated with the laptop computer and/or the mobile communication device. The signed weighting may be applied to each option based on the order of selection of each of the ‘n’ number of options by the user 108 (e.g., using the weighting module 204 of FIG. 2). The statistical probability algorithm may be used to determine the correlation between the user 108 and the other users 110 to determine the similarity value.

The bias may be placed (e.g., using the bias module 220 of FIG. 2) toward favoring similarity between the user 108 and/or other user through the biasing value when determining the correlation between the user 108 and the other users 110. The user-definable defined list based on the criteria of the user 108 may be customized (e.g., using the customization module 228 of FIG. 2). The user-definable defined list may be shared (e.g., using the sharing module 230 of FIG. 2) with other user. Only the user 108 that created the user-definable defined list may be permitted to delete (e.g., using the delete module 232 of FIG. 2) the user-definable defined list.

The defined list 402 module may create the defined list 402 having ‘n’ number of options of the set of items to the user 108 of the network. The allocation module 206 may transfer the set of items of the defined list 402 to the preference list 404 when the user 108 of the network identifies which of the ‘n’ number of options are preferred. The priority module 210 may determine the preference of the user 108 based on which of the ‘n’ number of options are preferred earlier than other ones of the ‘n’ number of options. The ordering module 216 may determine the ordering of the user 108 in response to the defined list 402 when all of the ‘n’ number of options are individually selected and/or allocated to the preference list 404 by the user 108 based on the order of selection of each of the ‘n’ number of options by the user 108.

The evaluation module 212 may compare the ordering of the user 108 with other users 110 connected to the user 108 through the network to generate a score. The similarity module 218 may determine the similarity value between the user 108 and the other users 110 connected to the user 108 through the network by applying an algorithm to the score, and when one user of the other users has provided responses to the defined list 402 having the ‘n’ number of options.

The weighting module 204 may apply the signed weighting to each option based on the order of selection of each of the ‘n’ number of options by the user 108. The statistics module 208 may apply a statistical probability algorithm to determine the correlation between the user 108 and the other users 110 to determine the similarity value. The bias module 220 may favor similarity between the user 108 and other user through the biasing value when determining the correlation between the user 108 and the other users 110. The customization module 228 may permit the user-definable defined list based on the criteria of the user 108. The sharing module 230 may communicate the user-definable defined list with one other user. The delete module 232 may permit only the user 108 that created the user-definable defined list to delete the user-definable defined list.

FIG. 3 is a user interface view illustrating a topic guide from which a topic can be selected and placed in the selected topic space, according to one embodiment. Particularly, FIG. 3 illustrates a topic guide 302, a selected topic 304, topics 306, and an item 308, according to one embodiment.

The topic guide 302 may list the topics 306 (e.g., like dancing, hiking, martial arts, etc.) that may be selected by the users according to their preferences. The selected topic 304 may list the topics 306 selected by the users from the topic guide 302 based on their order of preferences of the topics. The topics 306 may be the set of topics that the users may select from the topic guide to allocate them into the selected topic 304. The item 308 may be an item (e.g., a particular topic) selected from the list provided in the topic guide 302 by the user 108.

In example embodiment, the topic guide 302 may list the topics like ski, beach, drinking, dancing, gambling, sports, movies, watch TV, video games, and hiking. The selected topic may be listed in the selected topic 304.

FIG. 4A is a user interface view illustrating a selection of topic from defined list and adding the selected topic to the preference list based on a preference of a user, according to one embodiment. Particularly, FIG. 4A illustrates a defined list 402, a preference list 404, options 406, an item 408, a counter 410A, and a first selected option 412, according to one embodiment.

The defined list 402 may list the options 406 (e.g., topics that the users prefer to select) defined by the user 108 and/or the other users 110 connected through the network. The preference list 404 may be the selected options of the set of items that based on the preference of the user 108. The options 406 may be the various collection of set of items in the defined list 402 that may be selected by the users. The item 408 may be a particular item in the defined list 402. The counter 410A may show the remaining number of options in the defined list when the set of items of the defined list 402 may be allocated to the preference list 404 and removed from the defined list 402. A first selected option 412 may be one of the items selected by the user 108 for the first time illustrating that the selected item is the first preference of the user 108.

In example embodiment, FIG. 4A illustrates the selected topic 304 having the defined list 402 and the preference list 404. The defined list 402 may have the options 406 like the swimming, the hiking, the biking, the basketball, the volleyball, the Frisbee, the tennis, the jumping, etc. The preference list 404 may have the first selected option 412 like surfing. The defined list 402 may have the item 408 like hiking which may be one of the options in the defined list 402. The counter 410A may be updated based on number of selected items from the defined list 402 (e.g., ‘9’).

In one embodiment, the preference list 404 may be populated as each of the set of items are individually moved from the defined list 402 to the preference list 404. The preference list 404 may be rendered on the right-side location of the mark-up language page having the defined list 402 on the left-hand location of the mark-up language page such that both the defined list 402 and the preference list 404 may be simultaneously displayed to the user 108 having the limited display area.

The first ordering of the first user and the second ordering of the second user based on selected preferences (e.g., the first selected option 412 and/or the second selected option 414 etc.) may be determined on the defined list 402 of the topic when the first user and/or the second user independently remove items (e.g., ski, beach, dancing, etc) from the defined list 402 to the preference list 404 in the order of desirability of items of the defined list 402. The preference list 404 may be rendered on the right-side location of the mark-up language page having the defined list 402 on the left-hand location of the mark-up language page such that both the defined list 402 and/or the preference list 404 may be simultaneously displayed to the user 108 having the limited display area.

The preference list 404 may be modified when the first user and the second user may indicate through the final answer module 224 that the options 406 of the preference list 404 are not in the preferred order.

FIG. 4B is a user interface view illustrating a selection of topic (e.g., second option) from a defined list and adding the selected topic to a preference list based on the preference of the user, according to one embodiment. Particularly, FIG. 4B illustrates the defined list 402, the preference list 404, a counter 410B, the first selected option 412, and a second selected option 414, according to one embodiment.

The counter 410B may show the remaining number of options in the defined list 402 when the set of items of the defined list 402 may be allocated to the preference list 404 and removed from the defined list 402. The counter 410B may be updated based on number of selected topics in the defined list 402. The counter 410B may indicate the count ‘8’ which may illustrate that ‘8’ options are left out in the defined list 402 after selecting the items. The second selected option 414 may be an option selected second after the selection of the first selected option 412 by the user 108 indicating that the second selected option 414 may be the second preference of the user 108.

In example embodiment, FIG. 4B illustrates the defined list 402 and the preference list 404. The defined list 402 may have the options like the hiking, the biking, the basketball, the volleyball, the Frisbee, the tennis, the jumping, etc. The preference list 404 may have the first selected option 412 like surfing, and the second selected option 414 like swimming. The counter 410B may be updated based on number of selected items (e.g., ‘8’).

FIG. 4C is a user interface view illustrating a selection of topic (e.g., third option) from the defined list and adding the selected topic to the preference list based on a preference of the user, according to one embodiment. Particularly, FIG. 4C illustrates the defined list 402, the preference list 404, a counter 410C, a third selected option 416, and a function 417A, according to one embodiment.

The counter 410C may show the remaining number of options in the defined list 402 when the set of items of the defined list 402 may be allocated to the preference list 404 and removed from the defined list 402. The counter 410C may be updated based on number of selected topics given in the defined list 402. The counter 410C may indicate the count ‘7’ that may illustrate that ‘7’ options are left out in the defined list 402 after selecting the items. The third selected option 416 may be an option selected thirdly by the user 108 indicating that that the third selected option 416 is the third preference of the user 108. The function 417A may be an option that enables the user 108 to move the selected option up/down based on the preference (e.g., drag and drop).

In example embodiment, FIG. 4C illustrates the defined list 402 and the preference list 404. The defined list 402 may have the options like the biking, the basketball, the volleyball, the Frisbee, the tennis, the jumping, etc. The preference list 404 may have the surfing, the swimming, and the third selected option 416 like hiking. The counter 410C may be updated based on number of selected items (e.g., ‘7’). The function 417A may enable selecting from here moves it back to left side on down click (drag and drop later) may illustrate that the selected item in the preference list 404 may be moved back to the left side either by down click or drag and drop latter to the defined list 402.

FIG. 4D is a user interface view illustrating completed preference list by selecting the options from the defined list and adding them into the preference list based on preferences of the user, according to one embodiment. Particularly, FIG. 4D illustrates the defined list 402, the preference list 404, a last selected option 418, and a final answer selection 420, according to one embodiment.

The last selected option 418 may be an option selected at the last by the user 108 indicating that that the last selected option 418 may be the last preference of the user 108. The final answer selection 420 may indicate whether the options of the preference list 404 are in the preferred order of the user or not.

In example embodiment, FIG. 4D illustrates the defined list 402. The preference list 404 may have the selected options like surfing, basketball, volleyball, Frisbee, tennis, jumping, etc. The preference list 404 may have the last selected option 418 like jumping. The final answer selection 420 may be individually selected and allocated from the defined list 402 to the preference list 404 by the user 108.

In one embodiment, the preference list 404 may be modified when the user 108 may indicate through the final answer module 224 that the options 406 of the preference list 404 are not in the preferred order. The last selected item back to the defined list 402 may be moved from the preference list 404 when the user 108 may indicate that the options 406 of the preference list 404 are not in the preferred order. All items on the defined list 402 may be populated into the preference list 404 before the ordering is generated. The options 406 preferred earlier by the user 108 may be associated with items that may be more desirable by the user 108. The options 406 preferred last by the user 108 may be associated with items less desirable to the user 108. Each of the set of items of the defined list 402 may be associated with the topic of the defined list 402.

The set of items of the defined list 402 may be removed when the set of items of the defined list 402 are allocated to the preference list 404. The preference list 404 as each of the set of items is individually moved may be populated from the defined list 402 to the preference list 404. The last selected item (e.g., the last selected option 418 of FIG. 4D) may be moved back to the defined list 402 from the preference list 404 when the first user and/or the second user may indicate that the options 406 of the preference list 404 are not in the preferred order.

FIG. 5 is a table view illustrating algorithm for determining the similarity between the users, according to one embodiment. Particularly, FIG. 5 illustrates a choice ID field 502, an index (ranking) for first person field 504, a value 1 field 506, an index (ranking) for the second person field 508, a value 2 field 510, a calculation field 512, and a ordering field 514, according to one embodiment.

The choice id field 502 may illustrate the ids of the choices made by the users. The index (ranking) for first person field 504 may indicate the ranking of the first person. The value 1 field 506 may illustrate the values for the first person based on the choice id and the ranking associated to the first person.

The index (ranking) for the second person field 508 may indicate the ranking of the second person. The value 2 field may illustrate the value to the second person based on the ranking for second person. The calculation field 512 may illustrate the way in which the ordering of the user 108 is calculated as per the algorithm. The ordering field 514 (e.g., likeness) may be the product value of the values in the value 1 506 field and the value field 2 510.

In example embodiment, FIG. 5 illustrates the choice id field 502 that may show the various chosen numbers based on the preference to generate the ordering of the user 108 with other users 110 (e.g., 10, 11, 12, 13, 14, 15, 16, 17, 18, 19, etc). The index (ranking) for the first person field 504 may show the number of orderings for the first person and/or user 108 based on selected preferences on the defined list 402 (e.g., 2,4,1,3,5,8,7,10,6,9,etc.). The value 1 field 506 may illustrate the values 9, 5, 11, 7, 3, −3,−1, −7, 1, −5 in the consecutive rows of the field. The index (ranking) for the second person field 508 may indicate the indices 2, 1, 4, 5, 3, 10, 9, 6, 7, 8 in the consecutive rows. The value 2 field 510 may indicate the values 9, 11, 5, 3, 7, −7, −5, 1, −1, −3 in the consecutive rows. The formula field may illustrate product=value 1*value 2 and may illustrate the ordering (e.g., likeness number) as 81, 55, 55, 21, 21, 6, −7, −1 and 15.

FIG. 6 is a system view illustrating calculation of similarity value algorithm 650, according to one embodiment. Particularly, FIG. 6 illustrates a similarity value 602, according to one embodiment.

The similarity value algorithm 650 may be an algorithm used to calculate the similarity values between the user 108 and the other users 110 connected through the network. The similarity value 602 may be calculated using the similarity value algorithm 650 when the user 108 connected through the network has provided the response to the defined list 402 that may have ‘n’ number of options.

In example embodiment, similarity value algorithm 650 may explain the formula in which the similarity value 602 may be calculated. The percentage of matches for the user's selected options may be calculated using the below given formula as illustrated in the FIG. 6.

X=sum of last column+290

Percent match=[100/EXP (660, 0.07)]*EXP(X, 0.07).

In one embodiment, the similarity value 602 may be generated between the first user and the second user based on the algorithm (e.g., using the similarity value algorithm 650 of FIG. 6) that places signed weights based on the order of the selected preferences.

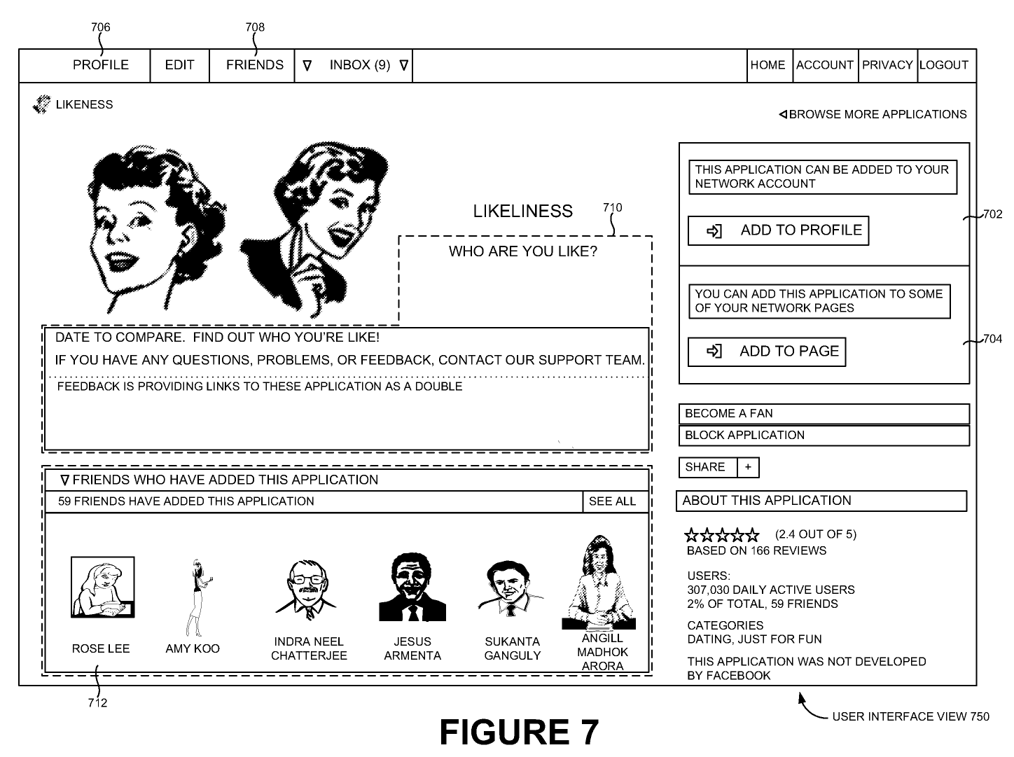

FIG. 7 is a user interface view 750 illustrating likeness profile, according to one embodiment. Particularly, FIG. 7 illustrates an option 702, an option 704, an option 706, an option 708, an option 710, and a block 712, according to one embodiment.

The option 702 may enable the user 108 (e.g., administrator, other users, etc.) to add the likeness application in their user account. The option 704 may enable the user 108 (e.g., administrator, other users, etc.) to add the application to any other page in the internet 104. The option 706 may be a link that may enable the user 108 (e.g., administrator) to check the user's profile.

The option 708 may be a link that may navigate the user 108 (e.g., the administrator, other user, etc.) friends list page. The option 710 may enable the user 108 (e.g., administrator, other user, etc.) to use the application to find out the likeness with the other users 110. The block 712 may illustrate the other users 110 who have added the application into their profile.

In example embodiment, FIG. 7 illustrates the option 702 that may be used for adding the likeness application into the user's profile. The option 704 may illustrate that the application can be embedded into other WebPages as well. The option 706 may navigate the user 108 to the user's profile. The option 708 may navigate the user 108 to the friends' list page. The option 710 may illustrate the likeness application to the user to check the likeness with the other users 110. The block 712 may illustrate all the friends who have added the application into their profile (e.g., Rose Lee, Amy Koo, Indra Neel, and Chetterjee, Jesus, and Armenta, Sukanta, and Ganguly, Angill, Madhok, and Arora).

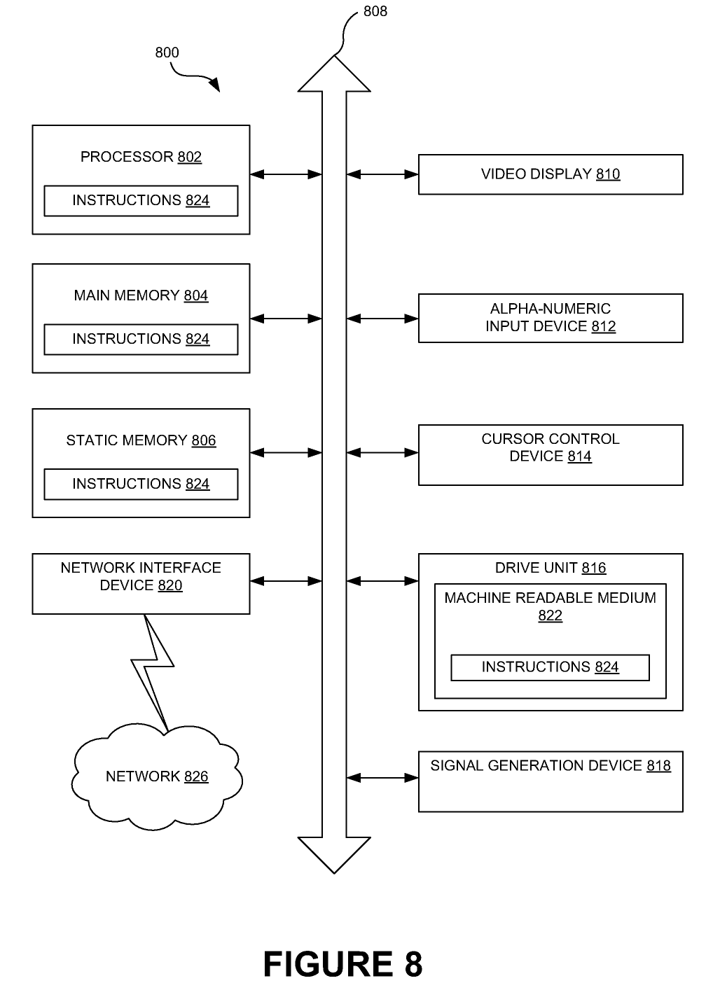

FIG. 8 is a diagrammatic system view of a data processing system in which any of the embodiments disclosed herein may be performed, according to one embodiment. Particularly, the diagrammatic system view 800 of FIG. 8 illustrates a processor 802, a main memory 804, a static memory 806, a bus 808, a video display 810, an alpha-numeric input device 812, a cursor control device 814, a drive unit 816, a signal generation device 818, a network interface device 820, a machine readable medium 822, instructions 824, and a network 826, according to one embodiment.

The diagrammatic system view 800 may indicate a personal computer and/or the data processing system in which one or more operations disclosed herein are performed. The processor 802 may be a microprocessor, a state machine, an application specific integrated circuit, a field programmable gate array, etc. (e.g., Intel® Pentium® processor). The main memory 804 may be a dynamic random access memory and/or a primary memory of a computer system.

The static memory 806 may be a hard drive, a flash drive, and/or other memory information associated with the data processing system. The bus 808 may be an interconnection between various circuits and/or structures of the data processing system. The video display 810 may provide graphical representation of information on the data processing system. The alpha-numeric input device 812 may be a keypad, a keyboard and/or any other input device of text (e.g., a special device to aid the physically handicapped).

The cursor control device 814 may be a pointing device such as a mouse. The drive unit 816 may be the hard drive, a storage system, and/or other longer term storage subsystem. The signal generation device 818 may be a bios and/or a functional operating system of the data processing system. The network interface device 820 may be a device that performs interface functions such as code conversion, protocol conversion and/or buffering required for communication to and from the network 826. The machine readable medium 822 may provide instructions on which any of the methods disclosed herein may be performed. The instructions 824 may provide source code and/or data code to the processor 802 to enable any one or more operations disclosed herein.

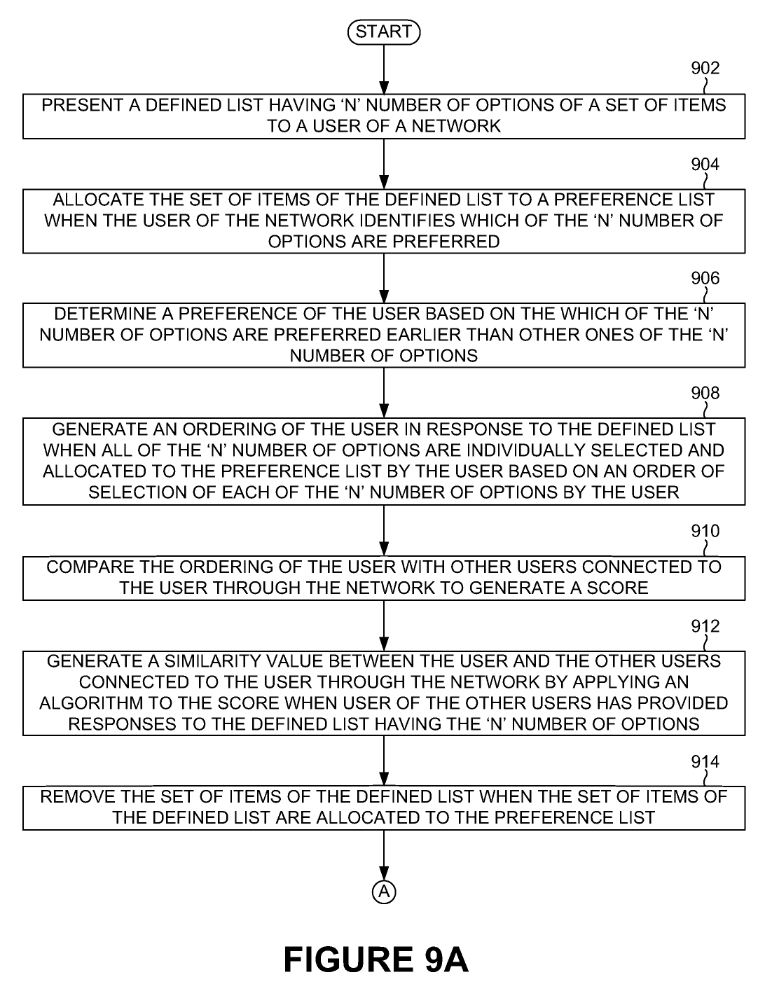

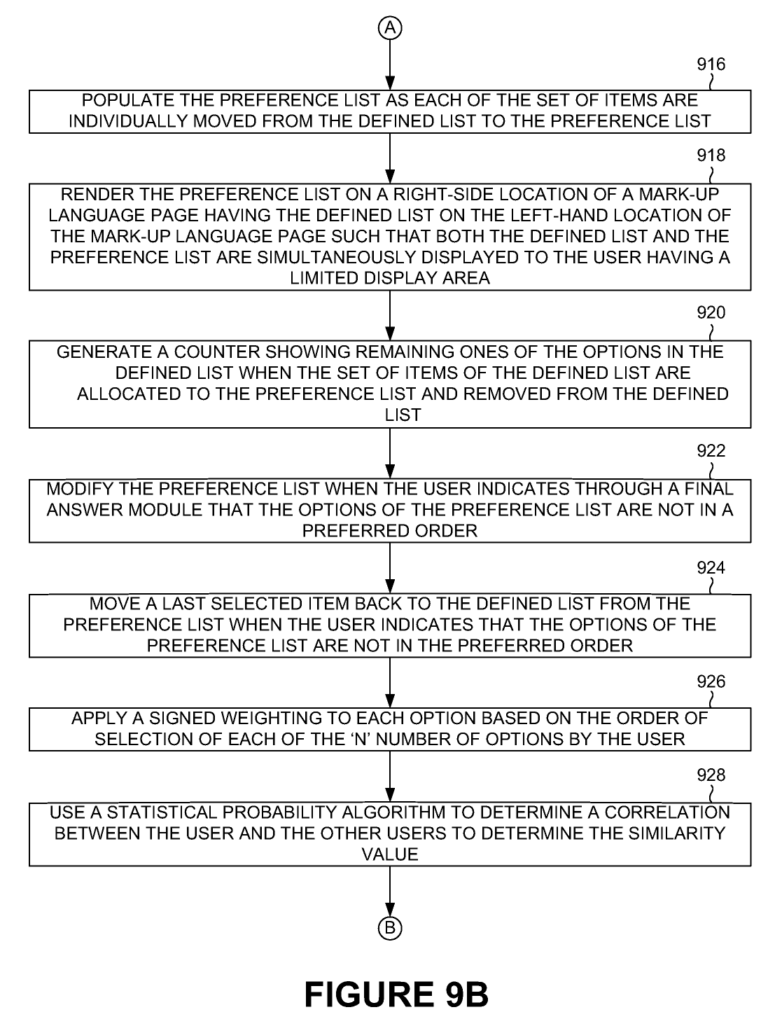

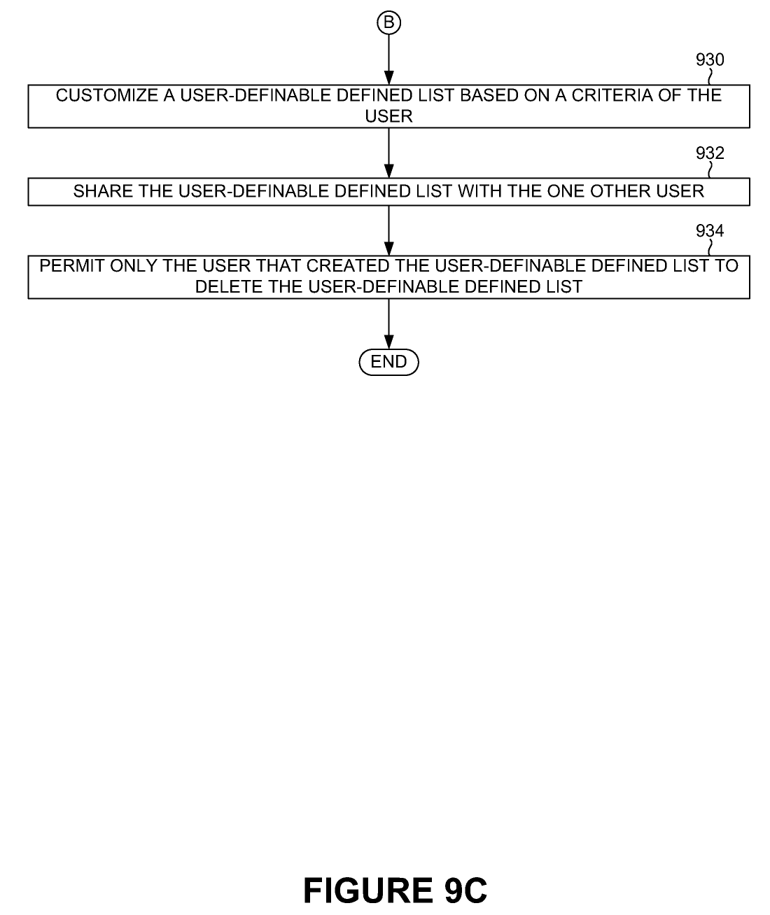

FIG. 9A is a process flow of presenting a defined list 402 having ‘n’ number of options of a set of items to a user (e.g., the user 108 of FIG. 1) of a network (e.g., the network of FIG. 1), according to one embodiment. In operation 902, a defined list 402 having ‘n’ number of options of a set of items may be presented (e.g., using the defined list module 200 of FIG. 2) to the user 108 of a network (e.g., social community environment). In operation 904, the set of items of the defined list 402 may be allocated (e.g., using the allocation module 206 of FIG. 2) to a preference list 404 when the user 108 of the network identifies which of the ‘n’ number of options are preferred. In operation 906, a preference of the user 108 may be determined (e.g., using the priority module 210 of FIG. 2) based on which of the ‘n’ number of options are preferred earlier than other ones of the ‘n’ number of options. In operation 908, an ordering of the user 108 in response may be generated (e.g., using the ordering module 216 of FIG. 2) to the defined list 402 when all of the ‘n’ number of options are individually selected and/or allocated to the preference list 404 by the user 108 based on an order of selection of each of the ‘n’ number of options by the user 108.

In operation 910, the ordering of the user 108 may be compared (e.g., using the evaluation module 212 of FIG. 2) with other users 110 connected to the user 108 through the network to generate a score. In operation 912, a similarity value may be generated (e.g., using the similarity module 218 of FIG. 2) between the user 108 and/or the other users 110 connected to the user 108 through the network by applying an algorithm to the score, and when one user of the other users has provided responses to the defined list 402 having the ‘n’ number of options. In operation 914, the set of items of the defined list 402 may be removed (e.g., using the remove module 226 of FIG. 2) when the set of items of the defined list 402 are allocated to the preference list 404.

FIG. 9B is a continuation of process flow of FIG. 9A, illustrating additional operations, according to one embodiment. In operation 916, the preference list 404 may be populated as each of the set of items are individually moved from the defined list 402 to the preference list 404. In operation 918, the preference list 404 may be rendered on a right-side location of a mark-up language page having the defined list 402 on a left-hand location of the mark-up language page such that both the defined list 402 and the preference list 404 may be simultaneously displayed to the user 108 having a limited display area. In operation 920, a counter may be generated (e.g., using the counter module 201 of FIG. 2) showing remaining ones of options in the defined list 402 when the set of items of the defined list 402 are allocated to the preference list 404 and/or removed from the defined list 402.

The limited display area may be associated with a laptop computer and/or a mobile communication device. In operation 922, the preference list 404 may be modified (e.g., using the preference list module 214 of FIG. 2) when the user 108 may indicate through a final answer module 224 that the options of the preference list 404 are not in a preferred order. In operation 924, a last selected item back to the defined list 402 may be moved (e.g., using the final answer module 224 of FIG. 2) from the preference list 404 when the user 108 indicates that the options of the preference list 404 are not in the preferred order. All items on the defined list 402 may be populated into the preference list 404 before the ordering is generated. The options preferred earlier by the user 108 may be associated with items that are more desirable to the user 108. Options preferred last by the user 108 may be associated with items less desirable to the user 108. Each of the set of items of the defined list 402 may be associated with a topic of the defined list 402. In operation 926, a signed weighting may be applied (e.g., using the weighting module 204 of FIG. 2) to each option based on the order of selection of each of the ‘n’ number of options by the user 108. In operation 928, a statistical probability algorithm may be used to determine a correlation between the user 108 and the at least one of the other users 110 to determine the similarity value. A bias may be placed toward favoring similarity between the user 108 and/or other user through a biasing value when determining the correlation between the user 108 and the other users 110.

FIG. 9C is a continuation of process flow of FIG. 9B, illustrating additional operations, according to one embodiment. In operation 930, a user-definable defined list based on criteria of the user 108 may be customized. In operation 932, the user-definable defined list may be shared (e.g., using the sharing module 230 of FIG. 2) with other user (e.g., other users 110 if FIG. 1). In operation 934, only the user that created the user-definable defined list may be permitted to delete (e.g., using the delete module 232 of FIG. 2) the user-definable defined list.

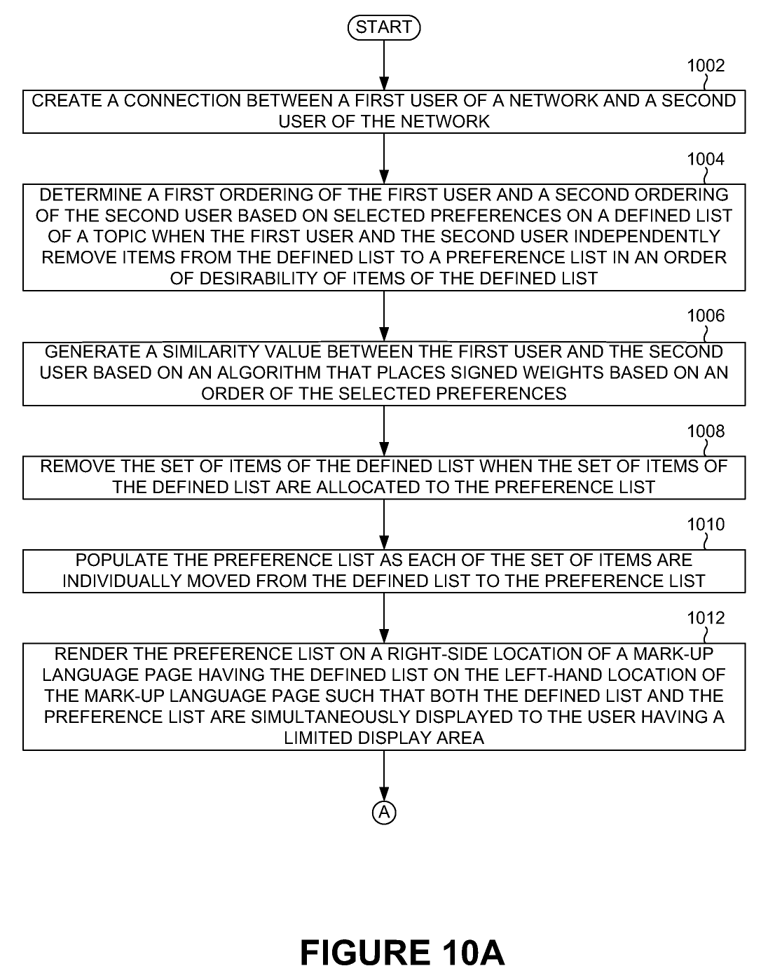

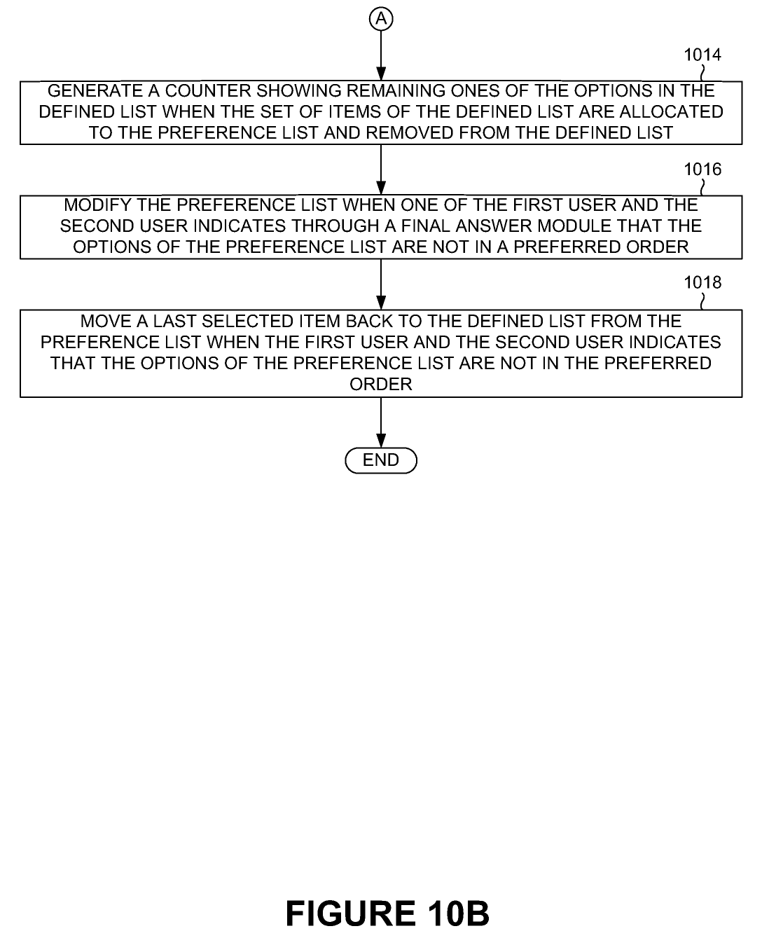

FIG. 10A is a process flow of creating a connection between a first user of a network (e.g., the network of FIG. 1) and a second user of the network, according to one embodiment. In operation 1002, a connection may be created between a first user of a network and a second user of the network. In operation 1004, a first ordering of the first user and a second ordering of the second user based on selected preferences may be determined on a defined list 402 of a topic when the first user and a second user independently remove items from the defined list 402 to a preference list (e.g., the preference list 404 of FIG. 4) in an order of desirability of items of the defined list 402. In operation 1006, a similarity value may be generated (e.g., using the similarity value algorithm 650 of FIG. 6) between the first user and the second user based on an algorithm that may place signed weights based on the order of the selected preferences.

In operation 1008, a set of items of the defined list 402 may be removed (e.g., using the remove module 226 of FIG. 2) when the set of items of the defined list 402 may be allocated to the preference list 404. In operation 1010, the preference list 404 may be populated as each of the set of items are individually moved from the defined list 402 to the preference list 404. In operation 1012, the preference list 404 may be rendered on a right-side location of a mark-up language page having the defined list 402 on a left-hand location of the mark-up language page such that both the defined list 402 and/or the preference list 404 may be simultaneously displayed to a user (e.g., the user 108 of FIG. 1) having a limited display area.

FIG. 10B is a continuation of process flow of FIG. 10A, illustrating additional operations, according to one embodiment. In operation 1014, a counter may be generated (e.g., using the counter module 201 of FIG. 2) showing remaining ones of the options in the defined list 402 when the set of items of the defined list 402 are allocated to the preference list 404 and removed from the defined list 402. The limited display area may be associated with a laptop computer and/or a mobile communication device. In operation 1016, the preference list 404 may be modified (e.g., using the final answer module 224 of FIG. 2) when the first user and the second user may indicate through a final answer module 224 that the options of the preference list 404 are not in a preferred order. In operation 1018, a last selected item may be moved back to the defined list 402 from the preference list 404 when the first user and the second user may indicate that the options of the preference list 404 are not in the preferred order.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

Particularly, the likeness module 112, the network module 102, the defined list module 200 the counter module 201, the weighting module 204, the allocation module 206, the statistics module 208, the priority module 210, the evaluation module 212, the preference list module 214, the ordering module 216, the similarity module 218, the bias module 220, the algorithm database 222, the final answer module 224, the remove module 226, the customization module 228, the sharing module 230, and the delete module 232 of FIG. 1-10 may be enabled using software and/or using transistors, logic gates, and electrical circuits (e.g., application specific integrated ASIC circuitry) such as a likeness circuit, a network circuit, a defined list circuit, a counter circuit, a weighting circuit, a allocation circuit, a statistics circuit, a priority circuit, a evaluation circuit, a preference circuit, a scoring circuit, a similarity circuit, a bias circuit, a algorithmic circuit, a final answer circuit, a remove circuit, a customization circuit, a sharing circuit, a delete circuit, and other circuit.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method comprising:
presenting a defined list having ‘n’ number of options of a set of items to a user of a network;
allocating the set of items of the defined list to a preference list when the user of the network identifies which of the ‘n’ number of options are preferred;
determining a preference of the user based on the which of the ‘n’ number of options are preferred earlier than other ones of the ‘n’ number of options;
generating an ordering of the user in response to the defined list when all of the ‘n’ number of options are individually selected and allocated to the preference list by the user based on an order of selection of each of the ‘n’ number of options by the user;
comparing the ordering of the user with other users connected to the user through the network to generate a score; and
generating a similarity value between the user and at least one of the other users connected to the user through the network by applying an algorithm to the score, and when at least one user of the other users has provided responses to the defined list having the ‘n’ number of options.

2. The method of claim 1 further comprising:
removing the set of items of the defined list when the set of items of the defined list are allocated to the preference list;
populating the preference list as each of the set of items are individually moved from the defined list to the preference list; and
rendering the preference list on a right-side location of a mark-up language page having the defined list on a left-hand location of the mark-up language page such that both the defined list and the preference list are simultaneously displayed to the user having a limited display area.

3. The method of claim 2 further comprising: generating a counter showing remaining ones of options in the defined list when the set of items of the defined list are allocated to the preference list and removed from the defined list.

4. The method of claim 2 wherein the limited display area is associated with at least one of a laptop computer and a mobile communication device.

5. The method of claim 2 further comprising:
modifying the preference list when the user indicates through a final answer module that options of the preference list are not in a preferred order; and
moving a last selected item back to the defined list from the preference list when the user indicates that the options of the preference list are not in the preferred order.

6. The method of claim 1 wherein all items on the defined list are populated into the preference list before the ordering is generated.

7. The method of claim 1 wherein the options preferred earlier by the user are associated with items that are more desirable to the user, and wherein the options preferred last by the user are associated with items less desirable to the user.

8. The method of claim 7 wherein each of the set of items of the defined list is associated with a topic of the defined list.

9. The method of claim 1 further comprising:
applying a signed weighting to each option based on the order of selection of each of the ‘n’ number of options by the user; and
using a statistical probability algorithm to determine a correlation between the user and the at least one of the other users to determine the similarity value.

10. The method of claim 9 wherein a bias is placed toward favoring similarity between the user and at least one other user through a biasing value when determining the correlation between the user and the at least one of the other users.

11. The method of claim 1 further comprising:
customizing a user-definable defined list based on a criteria of the user;
sharing the user-definable defined list with at least one other user; and
permitting only the user that created the user-definable defined list to delete the user-definable defined list.

12. The method of claim 1 in a form of a machine-readable medium embodying a set of instructions that, when executed by a machine, causes the machine to perform the method of claim 1.

13. A method comprising:
creating a connection between a first user of a network and a second user of the network;
determining a first ordering of the first user and a second ordering of the second user based on selected preferences on a defined list of a topic when the first user and a second user independently remove items from the defined list to a preference list in an order of desirability of items of the defined list; and
generating a similarity value between the first user and the second user based on an algorithm that places signed weights based on the order of the selected preferences.

14. The method of claim 13 further comprising:
removing a set of items of the defined list when the set of items of the defined list are allocated to the preference list;
populating the preference list as each of the set of items are individually moved from the defined list to the preference list; and
rendering the preference list on a right-side location of a mark-up language page having the defined list on a left-hand location of the mark-up language page such that both the defined list and the preference list are simultaneously displayed to a user having a limited display area.

15. The method of claim 14 further comprising: generating a counter showing remaining ones of options in the defined list when the set of items of the defined list are allocated to the preference list and removed from the defined list.

16. The method of claim 14 wherein the limited display area is associated with at least one of a laptop computer and a mobile communication device.

17. The method of claim 14 further comprising:
modifying the preference list when at least one of the first user and the second user indicates through a final answer module that the options of the preference list are not in a preferred order; and
moving a last selected item back to the defined list from the preference list when at least one of the first user and the second user indicates that the options of the preference list are not in the preferred order.

18. A system comprising:
a defined list module to create a defined list having ‘n’ number of options of a set of items to a user of a network;
an allocation module to transfer the set of items of the defined list to a preference list when the user of the network identifies which of the ‘n’ number of options are preferred;
a priority module to determine a preference of the user based on the which of the ‘n’ number of options are preferred earlier than other ones of the ‘n’ number of options;
a ordering module to determine a ordering of the user in response to the defined list when all of the ‘n’ number of options are individually selected and allocated to the preference list by the user based on an order of selection of each of the ‘n’ number of options by the user;
an evaluation module to compare the ordering of the user with other users connected to the user through the network to generate a score; and
a similarity module to determine a similarity value between the user and at least one of the other users connected to the user through the network by applying an algorithm to the score, and when at least one user of the other users has provided responses to the defined list having the ‘n’ number of options.

19. The system of claim 18 further comprising:
a weighting module to apply a signed weighting to each option based on the order of selection of each of the ‘n’ number of options by the user;
a statistics module to apply a statistical probability algorithm to determine a correlation between the user and the at least one of the other users to determine the similarity value; and
a bias module to favor similarity between the user and at least one other user through a biasing value when determining the correlation between the user and the at least one of the other users.

20. The system of claim 19 further comprising:
a customization module to permit a user-definable defined list based on a criteria of the user;
a sharing module to communicate the user-definable defined list with at least one other user; and
a delete module to permit only the user that created the user-definable defined list to delete the user-definable defined list.
